(19) United States
(12) Patent Application Publication
(10) Pub. No.: US 2004/0019686 A1
(43) Pub. Date: Jan. 29, 2004

(54) Switching node apparatus for storage network and method of accessing remote storage apparatus

(75) Inventors: Hidehiro Toyoda, Musashino (JP); Kazuyoshi Hoshino, Komae (JP); Norihiko Moriwaki, Kokubunji (JP); Makoto Kitani, Kokubunji (JP); Morihito Miyagi, Yokohama (JP); Masahiko Mizutani, Kokubunji (JP)

Correspondence Address: Stanley P. Fisher, Reed Smith Hazel & Thomas LLP, Suite 1400, 3110 Fairview Park Drive, Falls Church, VA, 22042-4503, US

(73) Assignee: Hitachi, Ltd.

(21) Appl. No.: 10/230,114

(22) Filed: Aug. 29, 2002

(30) Foreign Application Priority Data
Jul. 24, 2002 (JP) 2002-215184

(51) Int. Cl. G06F 15/16

(52) U.S. Cl. 709/229

(57) ABSTRACT

A switching node (MGS) 1 connected to a relay network 5 has a table 37 prestoring bandwidth control parameter values in correspondence with the size of data transferred via the relay network. When a request for accessing a remote storage apparatus is received, the switching node obtains the bandwidth control parameter values adapted to the transfer data size indicated by the access request are obtained from the table 37, and automatically sets a path having an optimum bandwidth on the relay network by using the parameter values. The path is automatically released when the data transfer is finished.

### BACKGROUND OF THE INVENTION

(1) Field of the Invention

The present invention relates to a switching node apparatus for a storage network and a method of accessing a remote storage apparatus. More particularly, the invention relates to a switching node apparatus suitable for connecting storage area networks (hereinbelow, abbreviated as SANs) in a plurality of sites via a relay network taking the form of a dedicated line, the IP (Internet Protocol) network, or the like, and a method of accessing a remote storage apparatus.

(2) Description of Related Art

An SAN is a network in which a storage apparatus typified by a magnetic disk and a computer apparatus such as a server or a user terminal are connected to each other via a high-speed digital data transmission path. As the high-speed digital data transmission path, a fibre channel (hereinbelow, called an FC) deliberated and standardized by the T11 committee of the ANSI (American National Standard Institute) is applied.

The FC is basically of a serial data transmitting method and, as a transmission medium, an optical fiber or a metal cable is used. Generally, when a metal cable is used as the transmission medium, a signal transmission distance is regulated to tens meters. When an optical fiber is applied, the signal transmission distance can be increased to about 10 km.

The FC has been inherently employed as a protocol for an LAN (Local Area Network). However, by applying an optical fiber, the signal transmission distance can be increased to about 10 km, so that a WAN (Wide Area Network) can be also configured with the FC protocol. A network configuration of connecting SANs spread in a plurality of sites by a relay network and accessing a storage apparatus in a site from a computer apparatus in another site can be also achieved.

Communication between a computer apparatus (user terminal or server) and a storage in an SAN is mostly performed for purposes of transfer of file data of a larger data amount as compared with that in communication between normal terminals. Therefore, in a storage network connecting SANs in a plurality of sites via a relay network, in the case of accessing a storage apparatus in a site from a computer apparatus in another site, the bandwidth of a communication path on the relay network becomes an issue.

Generally, an agreement made by the user to use a dedicated line with a carrier who provides a relay network such as a wide area IP network in order to reserve a path-bandwidth, is often a fixed bandwidth/ full-time-connection agreement. The fixed bandwidth denotes that a communication line (path) of a predetermined bandwidth (throughput) is assured on a relay network, and full-time-connection denotes that a communication line is regularly maintained in a connected state so that the user can always use the line.

Therefore, when a user who subscribes a low speed dedicated line tries to transfer an enormous amount of data, which is not adapted to the bandwidth of the line, such as a database file or LSI design data of a few gigabytes to a few terabytes, very long time is consumed for data transmission. On the contrary, in the case where the user subscribes a broadband line so that an enormous amount of data can be transferred in short time, since a charge according to the bandwidth is made also in a period in which the user does not use the line, it arises a problem that the cost is high.

When the user tries to set a path having a sufficient bandwidth for each data transmission in order to avoid the above problems, it is not easy to specify parameter values necessary for path setting/bandwidth reservation on a network and to execute a communication procedure.

### SUMMARY OF THE INVENTION

An object of the invention is to provide a network system capable of dynamically establishing a path having the optimum bandwidth adapted to the needs of the user.

Another object of the invention is to provide a switching node apparatus capable of establishing a communication path having the optimum bandwidth adapted to the amount of transfer data anytime and releasing the path at the end of communication.

Further another object of the invention is to provide a switching node apparatus for a storage network adapted to reserve a communication path of the optimum bandwidth on a relay network and to access a remote storage apparatus from one of sites.

Further another object of the invention is to provide a method of accessing a remote storage apparatus, suitable for transmitting a large amount of data via a relay network.

To achieve the objects, according to the present invention, bandwidth control parameter values are prestored in a switching node apparatus connected to a relay network in correspondence with the size or the attribution of file data to be transferred on the relay network. When an access request to a remote storage apparatus or a path setting request is received from the user, the switching node apparatus specifies the bandwidth control parameter values adapted to the request from the transfer data size or data attribution indicated by the request and automatically sets a path having the optimum bandwidth on the relay network by using the parameter values. On completion of the data transfer, the switching node apparatus automatically releases the path.

More specifically, a switching node apparatus of the invention is comprised of a first interface for connection to a relay network, a plurality of second interfaces for connection to an area network, and a path controller having an attribution table defining various bandwidth control parameters for each of size classifications of data to be transferred, and when a packet including a command for accessing a remote storage apparatus connected to the relay network is received from one of the second interfaces, the path controller reads out the bandwidth control parameters in the classification of the data size corresponding to a transfer data length indicated by the received command from the attribution table and executes a communication procedure for setting a path having a reserved bandwidth on the relay network in accordance with the bandwidth control parameters.

A switching node apparatus according to an embodiment of the invention includes: a first interface for connection to a relay network; a plurality of second interfaces for connection to an area network; a third interface for connection to a user terminal in the area network via a dedicated line; and a path controller having an attribution table defining various bandwidth control parameters for each of the attribution classifications of data to be transferred, wherein

when a path reservation request designating a data attribution is received from the third interface, the path controller reads out bandwidth control parameters in the attribution classification corresponding to the designated data attribution from the attribution table, and executes a communication procedure for setting a path having a reserved bandwidth on the relay network in accordance with the bandwidth control parameters, and

data is transferred between the user terminal and a remote storage apparatus via the path having the reserved bandwidth in accordance with a command received thereafter from one of the second interfaces.

A fibre channel protocol (FCP) is applicable to the area network, and the Internet Protocol (IP) is applicable to the relay network. In this case, the second interface has a function of protocol conversion between FCP packets and IP packets.

According to the invention, a method of accessing a remote storage apparatus in a network including a first storage area network and a second storage area network connected to a relay network via a first switching node and a second switching node, respectively, is comprised of the steps of:

transmitting a file access instruction from a computer apparatus belonging to the first storage area network to a storage apparatus belonging to the second storage area network;

receiving the file access instruction by the first switching node;

executing a communication procedure for setting a communication path on the relay network by the first switching node in cooperation with the second switching node while holding the transfer of the instruction to the relay network, said communication path having a bandwidth adapted to a transfer data length designated by the instruction; and

after the communication path is set, transferring the file access instruction from the first switching node to the storage apparatus, whereby performing data transfer according to the file access instruction between the computer apparatus and the storage apparatus via the communication path.

According to an embodiment of the invention, a method of accessing a remote storage apparatus is comprised of the steps of:

transferring file access instruction to the relay network by the first switching node when the first switching node receives the file access instruction;

executing a communication procedure for setting a communication path having a reserved bandwidth adapted to a transfer data length designated by the instruction on the relay network by the first switching node in cooperation with the second switching node;

after the file access instruction is received by the storage apparatus, performing data transfer according to the file access instruction between the computer apparatus and the storage apparatus via a standard communication path; and

after the communication path having the reserved bandwidth is set, performing data transfer according to the file access instruction between the computer apparatus and the storage apparatus via the communication path having the reserved bandwidth. In this case, the computer apparatus may perform communication with the storage apparatus prior to transmission of the file access instruction and obtains a transfer data length to be designated by the file access instruction.

A method of accessing a remote storage apparatus according to another embodiment of the invention is comprised of the steps of:

sending a request for reserving a communication path for accessing a storage apparatus belonging to the second storage area network, from a computer apparatus belonging to the first storage area network to the first switching node;

receiving the request by the first switching node;

executing a communication procedure for setting a communication path on the relay network by the first switching node in cooperation with the second switching node and, on completion of the communication procedure, notifying the computer apparatus of reservation of the communication path, the communication path having a reserved bandwidth adapted to a data attribution designated by the request; and

after reception of the notification of reservation of the communication path, transmitting a file access instruction from the computer apparatus to the disk, whereby performing data transfer according to the file access instruction between the computer apparatus and the disk apparatus via the communication path having the reserved bandwidth.

The above and other objects, features, and advantages of the invention will become apparent from the following description of embodiments with reference to the drawings.

### BRIEF DESCRIPTION OF THE DRAWINGS

FIG. 1 is a schematic block diagram of a storage network system to which switching nodes MGSs (1A and 1B) according to the invention are applied.

FIG. 2 is a block diagram showing a first embodiment of the MGS 1A.

FIG. 3 is a diagram for explaining conversion of the header of a transfer packet in the MGS.

FIG. 4 is a diagram showing an example of an SAN interface 10-1 illustrated in FIG. 2.

FIG. 5 is a diagram showing an example of an IP interface 20 illustrated in FIG. 2.

FIG. 6 is a diagram showing an example of a path controller 30 illustrated in FIG. 2.

FIG. 7 is a flowchart showing operations of an RSVP path management unit 31 as a component of the path controller 30.

FIG. 8 is a diagram showing the contents of an attribution table 37A referred to by the RSVP path management unit 31.

FIG. 9 is a diagram showing the contents of an RSVP path management table 38A referred to by the RSVP path management unit 31.

FIG. 10 is a diagram showing a packet transfer sequence in the case of reading out file data from a disk 3B to a user terminal 2A via the MGS of the first embodiment.

FIG. 11 is a diagram showing a packet transfer sequence in the case of writing file data from the user terminal 2A to the disk 3B via the MGS of the first embodiment.

FIG. 12 is a block diagram of an SAN interface 10-1 as a component of an MGS of a second embodiment.

FIG. 13 is a diagram showing a packet transfer sequence in the case of reading out file data from the disk 3B to the user terminal 2A via the MGS of the second embodiment.

FIG. 14 is a block diagram of the SAN interface 10-1 as a component of an MGS of a third embodiment.

FIG. 15 is a block diagram showing the path controller 30 as a component of the MGS of the third embodiment.

FIG. 16 is a diagram showing an example of a request 1600 for path reservation used in the MGS of the third embodiment.

FIG. 17 is a diagram showing an example of a request 1800 for path release used in the MGS of the third embodiment.

FIG. 18 is a diagram showing the contents of an attribution table 37B referred to by the RSVP path management unit 31 in the MGS of the third embodiment.

FIG. 19 is a diagram showing the contents of the RSVP path management table 38B referred to by the RSVP path management unit 31 in the MGS of the third embodiment.

FIG. 20 is a diagram showing a packet transfer sequence in the case of reading out file data from the disk 3B to the user terminal 2A via the MGS of the third embodiment.

FIG. 21 is a diagram showing a packet transfer sequence in the case of writing file data from the user terminal 2A to the disk 3B via the MGS of the third embodiment.

### DESCRIPTION OF THE PREFERRED EMBODIMENTS

Embodiments of the invention will be described hereinbelow with reference to the drawings.

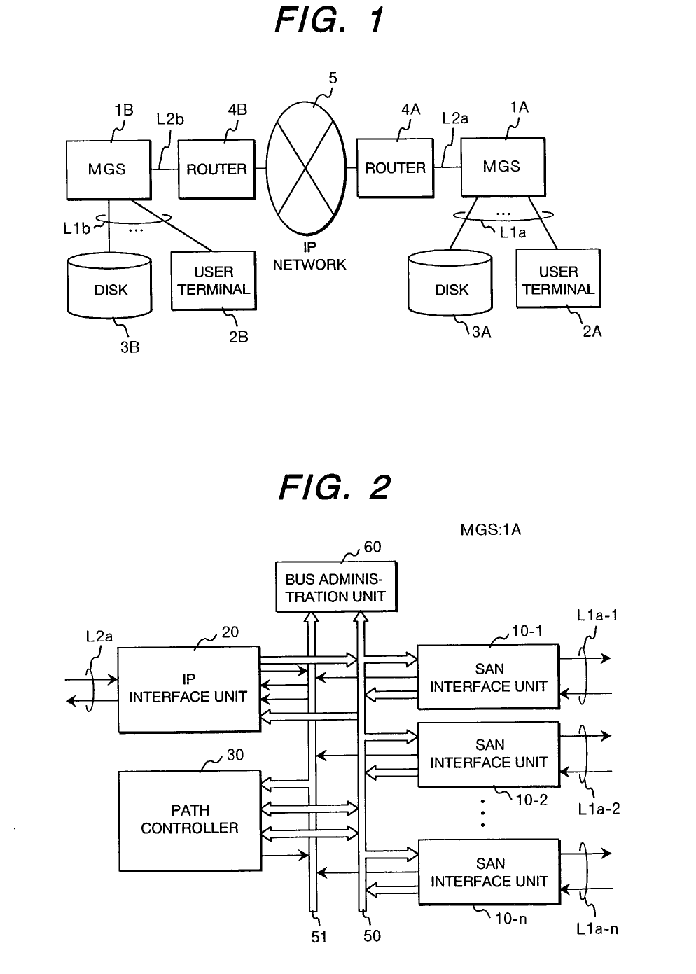

FIG. 1 shows a schematic configuration of a storage network according to the invention.

The storage network includes switching nodes (MGSs: Multi-protocol Gateway Switches) 1 (1A and 1B) accommodating user terminals 2 (2A and 2B) and disks 3 (3A and 3B), respectively, and routers 4 (4A and 4B) for connecting the MGSs to a relay network, for example, a wide area IP network 5. Each MGS 1 is connected to the user terminal 2 and the disk 3 via a transmission path L1 (L1a, L1b) and connected to the router 4 via a transmission path L2 (L2a, L2b).

The MGS 1A forms a local SAN in cooperation with the user terminal 2A and the disk 3A, and the MGS 1B forms another local SAN in cooperation with the user terminal 2B and the disk 3B. To each of the local SANs, other devices such as a server are also connected. In the specification, however, to simplify the description, the user terminal 2 represents computers accessing the disk, including the server and the like.

On the transmission path L1, for example, a fibre channel (FC) is applied. Since an SCSI (Small Computer System Interface) is generally applied to access the disk, the user terminal 2 and the disk 3 have an interface function of SCSI-FCP protocol conversion for converting an SCSI packet (command or data) into a packet of the fibre channel protocol (FCP), and outputting the packet to the transmission line L1 and, on the contrary, converting an FCP packet received from the transmission line L1 into an SCSI packet. The protocol on the transmission path L1 is not limited to the FC. For example, an iSCSI protocol for mapping the SCSI to the IP may be applied. A network connected via such a transmission line L1 is generally called an SAN (Storage Area Network).

The IP is used for communication on the transmission path L2. Therefore, the MGS 1 needs a function of protocol conversion such as the iSCSI for mapping the SCSI used in the SAN into the IP, FCIP (Fibre Channel over TCP/IP) for tunneling FCP to the IP network, and an iFCP (Internet Fibre Channel Protocol).

An object of the invention is to optimize a communication bandwidth on the IP network by MGS, for example, in the case where the disk 3B in a remote place is accessed by the user terminal 2A in a storage network in which a plurality of SANs are connected via the IP network 5 as shown in FIG. 1. In the following embodiment, the case of applying the FCIP to the MGS will be described. It is obvious that another protocol conversion such as iSCSI or iFCP is also applicable in place of the FCIP.

FIG. 2 is a block diagram showing an example of the MGS 1A. The MGS 1B have a configuration similar to the MGS 1A.

The MGS 1A includes a plurality of SAN interface units 10 (10-1 to 10-n) connected to transmission paths L1a (L1a-1 to L1a-n), an IP interface unit 20 connected to the transmission path L2a, a path controller 30, and a bus administration unit 60. These elements are connected to each other via a data bus 50 and a control bus 51. The bus administration unit 60 arbitrates conflict of the data bus 50 by the interface units 10 and 20 and the path controller 30 and controls a trouble on the bus via the control bus 51.

The SAN interface unit 10 encapsulates the FCP packet received from the transmission path L1a with an IP header, adds an internal header including routing information (switching information) to the IP header, and outputs the resultant packet as an internal packet to the data bus 50. The SAN interface unit 10 decapsulates the internal packet selectively received from the data bus 50 and outputs the resultant packet as an FCP packet to the transmission path L1a.

The IP interface unit 20 eliminates the internal header from the internal packet selectively received from the data bus 50 and outputs the resultant packet as an IP packet to the transmission path L2a. The IP interface unit 20 adds an internal header including the routing information to the IP packet selectively received from the transmission path L2a, and outputs the resultant packet as an internal packet to the data bus 50.

In the embodiment, in the case where the packet received from the transmission path L1a is an FCP data (FCP-DATA) packet destined for a remote disk connected to the IP network 5, each SAN interface unit 10 adds routing information destined for the IP interface 20 to the received packet and output the resultant packet to the data bus 50. When the received packet from the transmission path L1a is an FCP command (FCP-CMND) packet destined for a remote disk connected to the IP network 5, each of the SAN interface units 10 adds routing information destined for the path controller 30 to the received packet and output the resultant packet to the data bus 50. When the received packet from the data bus 50 is an FCP response (FCP-RSP) packet, each SAN interface unit 10 outputs the FCP-RSP packet to the transmission path L1a, and also outputs the FCP-RSP packet 50 to the data bus 50 after adding routing information destined for the path controller 30 to the packet.

In the case where the received packet from the transmission line L1a is a FCP-DATA packet or FCP-CMND packet destined for the disk connected to the MGS 1A or a FCP-DATA packet destined for the user terminal connected to the MGS 1A, routing information of the SAN interface corresponding to the destination is added to the received packet, and the resultant packet is output to the data bus 50.

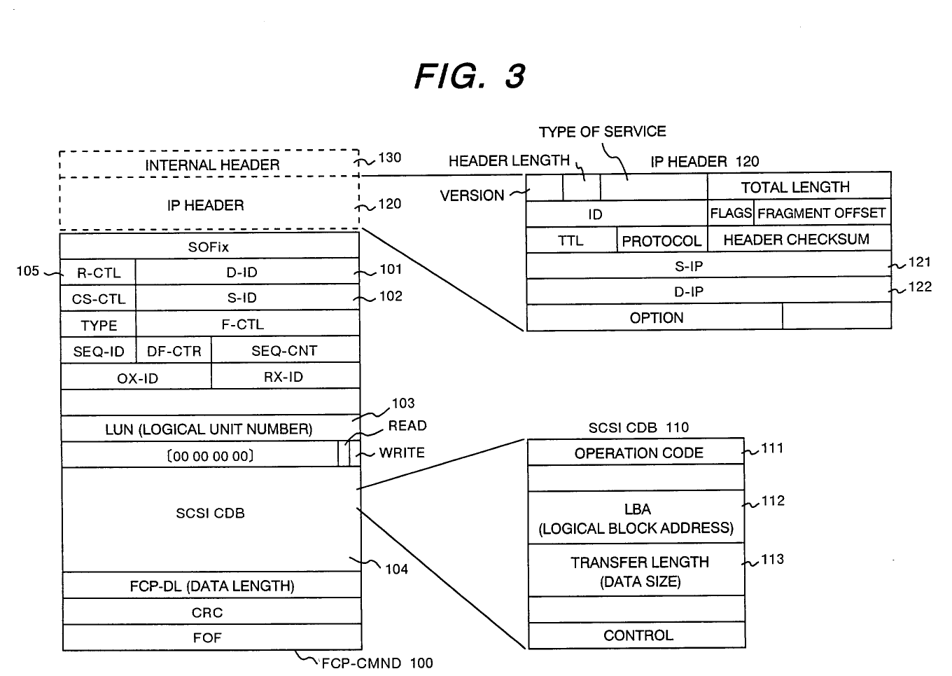

FIG. 3 shows the relation between the FCP packet received from the transmission path L1a and the internal packet. Numeral 100 denotes an FCP packet, 120 denotes an IP encapsulation header to be added to the FCP packet, and 130 denotes an internal header.

A case where the FCP packet 100 is an FCP command (FCP-CMND) is shown here. In the FCP-CMND, subsequent to a header portion including a destination address (D-ID) 101, a source address (S-ID) 102, and other information, a logical unit number (LUN) field 103 and an SCSI CDB (Command Description Block) field 104 indicative of a plurality of SCSI commands are provided. Each of the SCSI commands is set in the field 104 in the CDB form including an operation code 111, a logical block address (LBA) 112, and a transfer length 113 as shown by a block 110.

The type of the FCP packet 100 can be discriminated by a set value in an R-CTL field 105. The set value “6” in the field 105 indicates the FCP-CMND, and the set value “7” indicates the FCP-RSP. The IP header 120 includes a source IP address (S-IP) 121, a destination IP address (D-IP) 122, and other information. In the internal header 130, as routing information, an identification number of one of the other interface units and the path controller 30 connected to the data bus 50 is set.

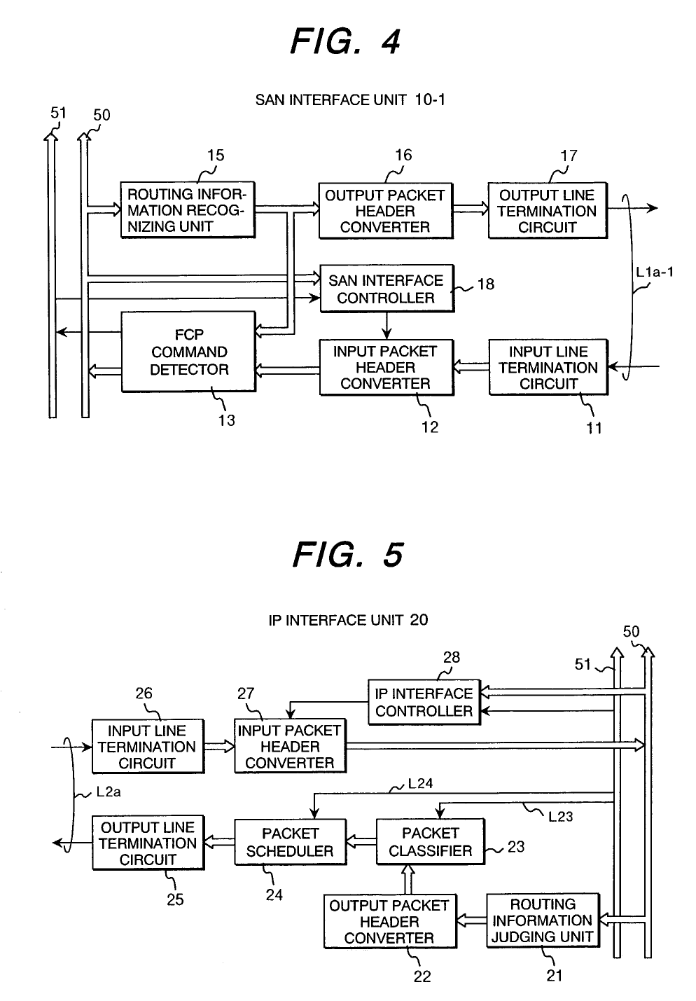

FIG. 4 shows the configuration of the SAN interface unit 10-1.

The SAN interface unit 10-1 includes an input line termination circuit 11 for terminating digital signals received from the transmission line L1a-1 to output as FCP packets, an input packet header converter 12 for converting each of the FCP packets into an internal packet to which the IP encapsulation header 120 and the internal header 130 are added, and an FCP command detector 13 to which the internal packet is supplied.

The input packet header converter 12 has an address conversion table (not shown) and obtains the destination IP address (D-IP) 122 corresponding to the destination address (D-ID) 101 extracted from the header portion of the FCP packet and output interface number (internal routing information) by referring to the table. The input packet header converter 12 also obtains the source IP address (S-IP) 121 corresponding to the source address (S-ID) 102 in the FCP packet from the address conversion table and generates the IP encapsulation header 120 and the internal header 130 by applying the IP addresses and internal routing information.

The SAN interface 10-1 further includes: a routing information recognizing unit 15 for judging the internal header of the internal packets passing through the data bus 50 and selectively receiving internal packets having routing information destined for the interface itself (SAN interface 10-1); an output packet header converter 16 for removing the internal header and the IP header from output packets of the recognizing unit 15 and outputting the resultant packet as FCP packets; an output line termination circuit 17 for outputting the FCP packets as digital signals to the transmission line L1a-1; and an SAN interface controller 18. The contents of the address conversion table associated with the input packet header converter 12 are updated through the SAN interface controller 18.

The FCP command detector 13 determines the contents of the internal packets supplied from the input packet header converter 12 and the routing information recognizing unit 15. In the case where the internal packet supplied from the input packet header converter 12 includes the FCP-CMND and the routing information destined for the IP interface unit, the FCP command detector 13 rewrites the routing information of the internal header with routing information destined for the path controller 30 and outputs the resultant packet to the data bus 50. The FCP command detector 13 outputs internal packets other than the FCP-CMND destined for the IP interface as they are without rewriting the routing information.

On the other hand, when the internal packet supplied from the routing information recognizing unit 15 includes the FCP-RSP, the FCP command detector 13 rewrites the routing information of the internal header with routing information destined for the path controller 30, outputs the resultant packet to the data bus 50, and discards internal packets other than the FCP-RSP. In such a manner, the FCP-CMND destined for the remote disk generated by the SAN and the FCP-RSP generated from the remote disk are transferred to the path controller 30.

FIG. 5 shows the configuration of the IP interface unit 20.

The IP interface unit 20 includes: a routing information judging unit 21 for judging the internal header of the internal packets passing through the data bus 50 and selectively receiving internal packets having routing information destined for the interface itself (IP interface unit 20); an output packet header converter 22 for converting output packets from the judging unit 21 into IP packets by removing the internal header 130 from the received output packets; a packet classifier 23 and packet scheduler 24 for controlling a rate of transfer to the transmission line L2a of the IP packets; and an output line termination circuit 25 for converting output packets from the packet scheduler 24 into digital signals to transmit to the transmission line L2a.

The packet classifier 23 classifies IP packets in accordance with QoS (Quality of Service) of the RSVP (Resource Reservation Protocol) in accordance with classifier information output from the path controller 30 to a control signal line L23 as will be described hereinafter. The packet scheduler 24 controls the transmission interval of IP packets so as to conform to the path bandwidth assured by the RSVP in accordance with scheduler information output from the path controller 30 to the control signal line L24 and the QoS class of each IP packet.

The IP interface unit 20 further includes: an input line termination circuit 26 for terminating the digital signals received from the transmission line L2a to output as IP packets; an input packet header converter 27 for adding an internal header including the routing information to each of the IP packets output from the input line termination circuit 26 and transmitting the resultant packets as internal packets to the data bus 50; and an IP interface controller 28 for updating the contents of an address conversion table (not shown) referred to by the input packet header converter 27.

The input packet header converter 27 checks the destination IP address of each IP packet received from the input line termination circuit 26 and, if the IP packet has a destination IP address that has been already registered in the address conversion table, generates an internal header in accordance with the address conversion table, and converts the IP packet into an internal packet. IP packets each having a destination IP address that has not been registered in the address conversion table is discarded.

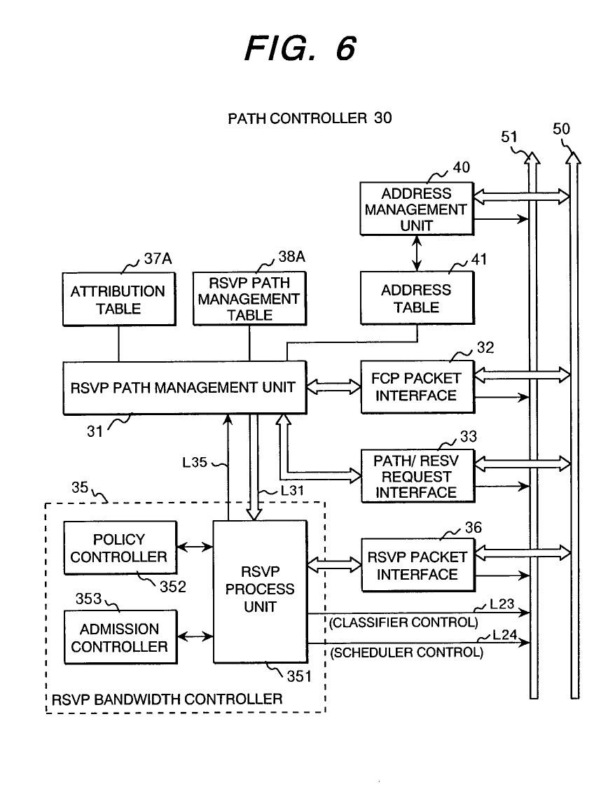

FIG. 6 shows an example of the path controller 30.

The path controller 30 includes: an RSVP path management unit 31: an FCP packet interface 32 and a PATH/RESV request interface 33 connected between the data bus 50 and the RSVP path controller 31; an RSVP bandwidth controller 35 connected to the RSVP path controller 31; an RSVP packet interface 36 connected between the RSVP bandwidth controller 35 and the data bus 50; and an address management unit 40 for managing an address table 41.

The FCP packet interface 32 selectively receives internal packets having routing information destined for the path controller 30 from the data bus 50 and, in the case where the internal packet includes the FCP-CMND or FCP-RSP, transfers the internal packet to the RSVP path management unit 31. After completion of execution of the RSVP procedure, the FCP packet interface 32 outputs the FCP-CMND packet issued by the RSVP path management unit 31 to the data bus 50.

The PATH/RESV request interface 33 selectively receives internal packets having routing information destined for the path controller 30 from the data bus 50 and, in the case where the internal packet includes a PATH(RSVP) message or an RSVP request permission message which will be described later, transfers the internal packet to the RSVP path management unit 31. Prior to execution of the RSVP bandwidth reservation procedure, the PATH/RESV request interface 33 outputs a packet for PATH request or RESV request issued by the RSVP path management unit 31 to the data bus 50.

The address management unit 40 manages total address conversion information within the MGS 1A in the address table 41, and updates the contents of a local address conversion table used by the SAN interface units 10-i (i=1 to n) and the IP interface unit 20 via the data bus 50.

The embodiment is characterized in that the RSVP path management unit 31 executes the path setting/bandwidth reservation procedure according to the RSVP in a state where the FCP-CMND packet received from the SAN interface units 10-i (i=1 to n) via the FCP packet interface 32 is temporarily held in the RSVP path management unit 31. On completion of the bandwidth reservation according to the RSVP, the IP packet for the FCP-CMND is transferred from the RSVP path management unit 31 to the IP interface unit 20 via the FCP packet interface 32 and the data bus 50 and transmitted to the IP network.

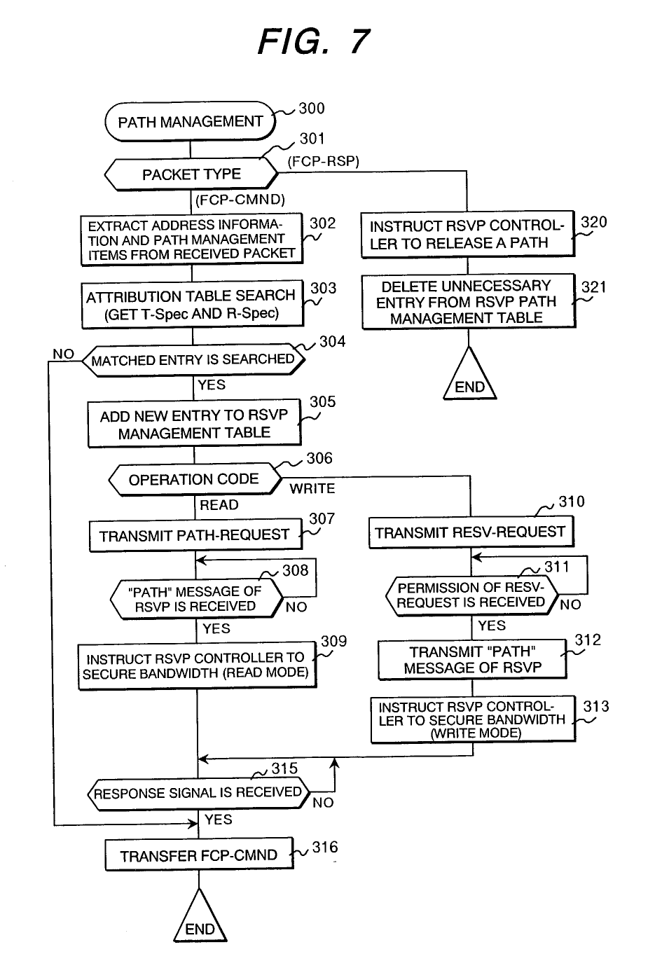

The RSVP path management unit 31 operates in accordance with a path management flowchart 300 shown in FIG. 7.

When the internal packet is received from the FCP packet interface 32, the RSVP path management unit 31 determines the type of the received packet (step 301). In the case where the received packet includes the FCP-CMND, the RSVP path management unit 31 extracts the S-IP address and the D-IP address from the IP header of the received packet, the S-ID address and the D-ID address from the FCP header, and the logical unit number (LUN) 103, the logical block address (LBA) 112, and the transfer length 113 as path management items from the FCP-CMND (step 302).

The RSVP path management unit 31 refers to an attribution table 37A by using the transfer length 113 as a retrieval key and obtains parameter values necessary for determining necessity of setting of the bandwidth and path setting/bandwidth reservation (step 303).

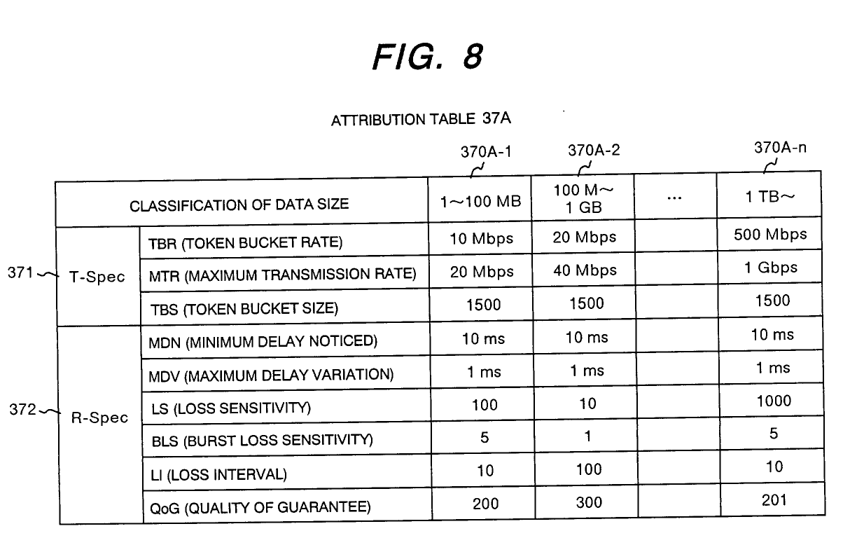

The attribution table 37A is used to designate various parameter values necessary for bandwidth control according to the RSVP. For example, as shown in FIG. 8, the attribute table 37A includes parameter entries for each of classifications 370A-1 to 370A-n of data size.

Each entry defines values of, as a first parameter group T-Spec 371, a token bucket rate TBR, a maximum transmission rate MTR, and a token bucket size TBS, and as a second parameter group R-spec 372, a minimum delay noticed MDN, a maximum delay variation MDV, a loss sensitivity LS, a burst loss sensitivity BLS, a loss interval LI, and quality of guarantee QoG. When the transfer length 113 as a retrieval key is shorter than the minimum data size classification 370A-1, it is determined that peculiar path setting and bandwidth reservation are unnecessary.

When no parameter entry corresponding to the transfer length 113 exists in the attribution table 37A (step 304), the RSVP path management unit 31 rewrites the routing information of the internal header of the FCP-CMND packet temporarily held to routing information destined for the IP interface unit 20 and outputs the resultant packet to the FCP packet interface 32 (step 316). In this case, the FCP-CMND is transferred to the disk 3B to be accessed without performing special path setting and bandwidth reservation, so that data read out from the disk 3B in response to the FCP-CMND is transferred to the MGS 1A in a standard bandwidth on the IP network.

When a parameter entry corresponding to the transfer length 113 is found in the attribution table 37A, the RSVP path management unit 31 registers a new entry corresponding to the FCP-CMND into the RSVP management table 38A (step 305).

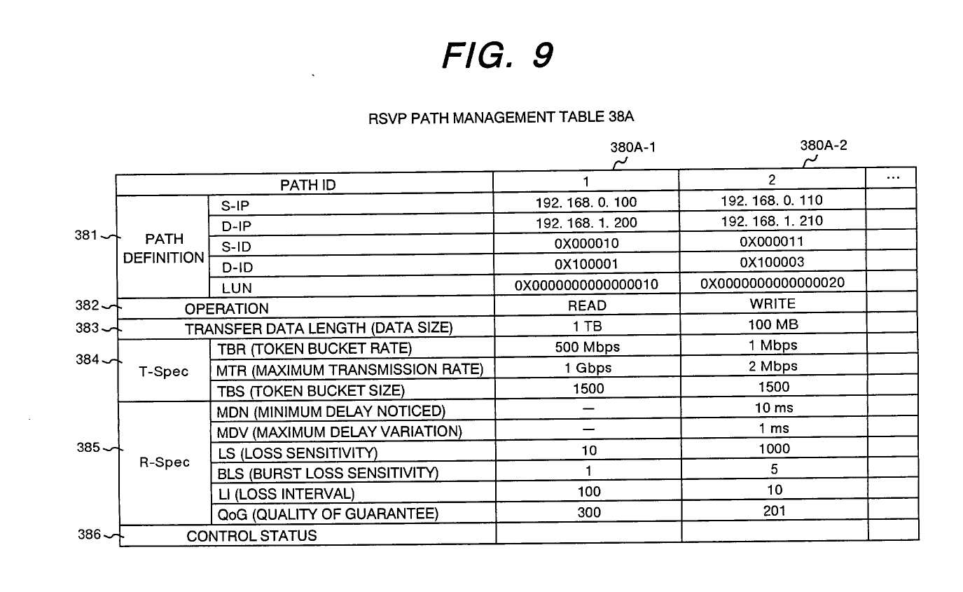

The RSVP management table 38A includes, for example as shown in FIG. 9, a plurality of entries 380A-1, 380A-2, . . . each having a path ID. Each entry is comprised of path definition information 381, operation 382, transfer data length (data size) 383, T-spec 384, R-spec 385, and control status 386. As the path IDs, sequential numbers are assigned to received FCP-CMNDs.

In the path definition information 381, the S-IP address 121 and D-IP address 122 extracted from the IP header of the internal packet, the S-ID address 102 and D-ID address 101 extracted from the FCP header, and the LUN 103 designated by the FCP command are set. In the operation 382, the operation code 111 extracted from the SCSI CDB 110 is set. In the transfer data length 383, the value of the transfer data length applied for searching the attribution table is set. In the T-spec 384 and R-spec 385, the parameter values obtained by searching the attribution table 37A are set. The control status 386 is used to control a status transition of the path setting/bandwidth reservation procedure. An entry registered in the RSVP path management table 38A is erased when an FCP-RSP is received as will be described later.

In the case of reserving the path bandwidth by the RSVP, not only the above-described path definition information, but also UDP port number of the RSVP and TCP port number of the FCIP are necessary. Since the former value is known as the fixed value “363” and the latter value is known as the fixed value “3225”, it is unnecessary to store these values for each entry in the RSVP path management table 38A. In the following description, the word “path definition information” includes the UDP port number and the PCT port number.

When registration of a new entry to the RSVP path management table 38A is finished, the RSVP path management unit 31 generates a command for setting an SRVP path to the MGS on the disk side to be accessed, and outputs the command to the PATH/RESV request interface 33. The procedure of setting the SRVP path varies depending upon whether the access to the disk is a read access or a write access. Accordingly, the operation code of the FCP-CMND is judged (step 306).

When the operation is a read access, that is, when a path used for data transfer from the disk to the user terminal is required, a path request destined for the MGS 1B on the disk side is transmitted (step 307), and the RSVP path management unit 31 waits for reception of a request permission message from the MGS 1B (step 308).

On the other hand, when the operation code of the FCP-CMND is “write”, that is, when a path used for data transfer from the user terminal to the disk is required, the RSVP path management unit 31 transmits an RESV request to the MGS 1B on the disk side (step 310), waits for reception of the request permission message from the MGS 1B (step 311) and, when the request permission message is received, transmits a message PATH(RSVP) for path setting to the MGS 1B (step 312). The messages for path setting are communicated with the IP interface unit 20 via the PATH/RESV request interface 33.

On completion of setting of the RSVP path to the MGS 1B on the disk side, the RSVP path management unit 31 instructs the RSVP bandwidth controller 35 to reserve the bandwidth on the path (steps 309 and 313), and waits for a response signal (a notification of bandwidth reservation complete) from a signal line L35 (step 315). The bandwidth reservation instruction is issued by designating the path definition information 381 to the R-spec information 385 retrieved from the RVSP path management table 38A.

The RSVP bandwidth controller 35 is comprised of an RSVP process unit 351, a policy controller 352, and an admission controller 353 as shown in FIG. 6.

When the operation code of the FCP-CMND is “read”, a control message RESV(RSVP) for bandwidth reservation is transmitted from the user terminal side. In this case, the RSVP process unit 351 generates RESV(RSVP) by using the path definition information 381, T-spec information 384, R-spec information 385, the known UDP port number of RSVP, and the known TCP port number of FCIP which are designated by the RSVP path management unit 31, and transmits the RESV to the MGS 1B on the disk side. By the operation, the control procedure of the bandwidth reservation is executed on the IP network between the MGS 1B and the MGS 1A.

When the operation code of the FCP-CMND is “write”, the control message RESV(RSVP) is transmitted from the MGS 1B on the disk side. In response to the RESV(RSVP) the RSVP process unit 351 on the user terminal side transmits a confirmation message RESV-Conf(RSVP). The RSVP control messages are communicated via the RSVP packet interface 36.

After reservation of the RSVP path bandwidth is completed, the RSVP process unit 351 outputs a notification of reservation complete to the signal line L35. On reception of the notification from the signal line L35, the RSVP path management unit 31 rewrites the routing information of the internal packet (FCP-CMND) temporarily stored therein to new routing information destined for the IP interface unit 20, and outputs the resultant packet to the FCP packet interface 32 (step 316). In this case, the FCP-CMND is transferred to the disk 3B to be accessed after completion of setting of the path having a special bandwidth adapted to the transfer data length. Consequently, data read out from the disk 3B in response to the FCP-CMND is transferred to the MGS 1A in the peculiar path bandwidth reserved on the IP network.

When the data transfer according to the FCP-CMND is completed, FCP-RSP is issued from the disk 3B. An IP packet including the FCP-RSP is received by the IP interface 20 of the MGS 1A and transferred to a SAN interface 10-j to which the user terminal as a requester is connected. In this case, as described in FIG. 4, the SAN interface 10-j transfers the IP packet including the FCP-RSP to the path controller 30 and transmits the FCP-RSP extracted from the received IP packet to the transmission path L1a-j.

The IP packet including the FCP-RSP is input to the RSVP path management unit 31 via the FCP packet interface 32. When the FCP-RSP is received, the RSVP path management unit 31 retrieves an entry corresponding to a combination of D-ID and S-ID indicated by the FCP header from the RSVP path management table 38A and instructs the RSVP bandwidth controller 35 to release a path by designating the path definition information (step 320). It makes the RSVP process unit 351 issue a path release command (RESV_Tear_Down), and the RSVP path is released. The RSVP path management unit 31 eliminates the entry which becomes unnecessary due to the path release from the RSVP path management table 38A (step 321). When an entry corresponding to the combination of the D-ID and S-ID of the FCP-RSP is not found in the RSVP path management table 38A, the FCP-RSP is ignored since it relates to a disk access for which a peculiar path bandwidth has not reserved.

The policy controller 352 and the admission controller 353 in the RSVP bandwidth controller 35 are used to control data transfer in the path bandwidth reserved by the RSVP. The packet classifier 23 and the packet scheduler 24 in the IP interface unit 20 described by referring to FIG. 5 are controlled by scheduler/classifier control signals output from the RSVP process unit 351 to signal lines L23 and L24.

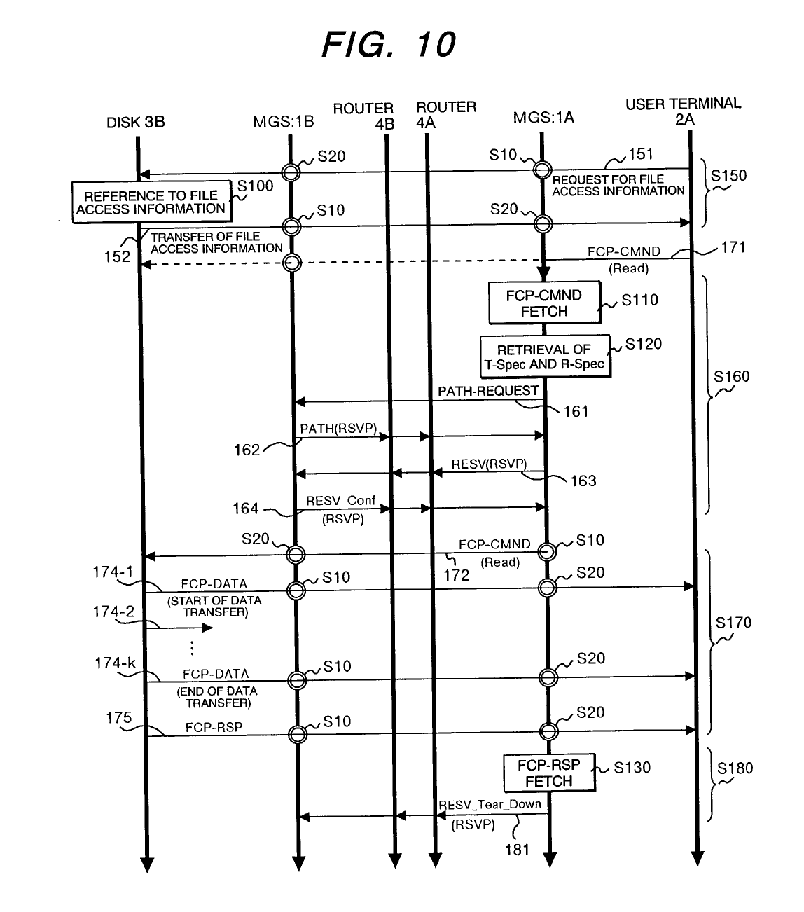

FIG. 10 shows a packet transfer sequence of the case in which the user terminal 2A shown in FIG. 1 accesses the disk 3B via the MGSs 1A and 1B having the above-described configuration to read out file data.

The packet transfer sequence is comprised of a preprocess sequence (S150), a path setting/bandwidth reservation sequence (S160), a block data transfer sequence (S170), and a path release sequence (S180) In the embodiment, the path setting/bandwidth reservation sequence (S160) is executed prior to the block data transfer sequence (S170).

The preprocess sequence (S150) is a sequence executed before the user terminal 2A accesses a data file stored in the disk 3B. In the preprocess sequence, the user terminal 2A requests the disk 3B for file access information necessary for the FCP-CMND (151). When the file access information request is received, the disk 3B executes a process of referring to a file access information table (S100) and returns the requested file access information to the user terminal 2A (152). The file access information includes the logical unit number (LUN) of a data file to be accessed, the logical block address (LBA) of the data file, and the data size (transfer length). The preprocess sequence is realized through the functions of OS (Operating System) of the user terminal 2A and a file system of the disk 3B.

In this embodiment, it is assumed that the user terminal 2A accesses the disk 3B with SCSI commands, and communication between the user terminal 2A and the MGS 1A and between the disk 3B and the MGS 1B is performed with FCP. In FIG. 10, S10 executed by the MGSs 1A and 1B denotes a protocol conversion process from the FCP to the IP, and S20 denotes a protocol conversion process from the IP to the FCP.

The block data transfer sequence (S170) corresponds to a read sequence in which the user terminal 2A operates as an SCSI initiator and the disk 3B operates as an SCSI target in the SCSI-FCP. The block data transfer sequence (S170) is started by transmission (171) of an FCP command FCP-CMND(read) from the user terminal 2A. In this embodiment, as described by referring to FIG. 6, the FCP-CMND is temporarily stored in the MGS 1A and, after completion of the path setting/bandwidth reservation sequence (S160), transmitted to the disk 3B. Consequently, the substantial block data transfer sequence (S170) is started by transmission (172) of the FCP-CMND (read) from the MGS 1A, and finished by transmission (175) of the FCP-RSP from the disk 3B.

The FCP-CMND(read) is generated in accordance with file access information obtained by the preprocess sequence. Upon receiving the FCP-CMND (read) from the MGS 1A, the disk 3B reads out data on the unit basis of a data block of a predetermined size from a data file designated by the FCP-CMND(read) and transmits the data blocks as FCP-DATA to the user terminal 2A (174-1, 174-2, . . . ). When transmission of the last data block of the designated data file is completed (174-k), the FCP-RSP is issued from the disk 3B (175).

In the path setting/bandwidth reservation sequence (S160), the path controller 30 of the MGS 1A fetches the FCP-CMND (S110), determines whether the RSVP path setting is necessary or not and retrieves the bandwidth control parameters (T-spec and R-spec) (S120), generates a path request including the bandwidth control parameters and information such as path definition information described in FIG. 9, and transmits the path request to the MGS 1B opposite on the IP network (161).

In response to the path request, a message PATH(RSVP) for path setting is transmitted from the MGS 1B to the MGS 1A (162), thereby setting a communication path between the two MGSs. In a state where the communication path has been set, a message RESV(RSVP) for reserving a desired bandwidth on the communication path is transmitted from the RSVP bandwidth controller 35 of the MGS 1A to the MGS 1B (163), and a confirmation message RESV-conf (RSVP) is transmitted from the MGS 1B to the MGS 1A (164), whereby a desired bandwidth by the RSVP is reserved on the communication path between the MGSs 1A and 1B.

The path release sequence (S180) is started when the path controller 30 of the MGS 1A fetches the FCP-RSP transmitted from the disk 3B to the user terminal 2A (S130). The RSVP path management unit 31 of the MGS 1A reads out path management information corresponding to the FCP-RSP from the RSVP path management table 38A, generates a path release command (RESV-Tear-Down) of the RSVP, and transmits the command to the MGS 1B (181), thereby releasing the communication path established by the PATH(RSVP) 162.

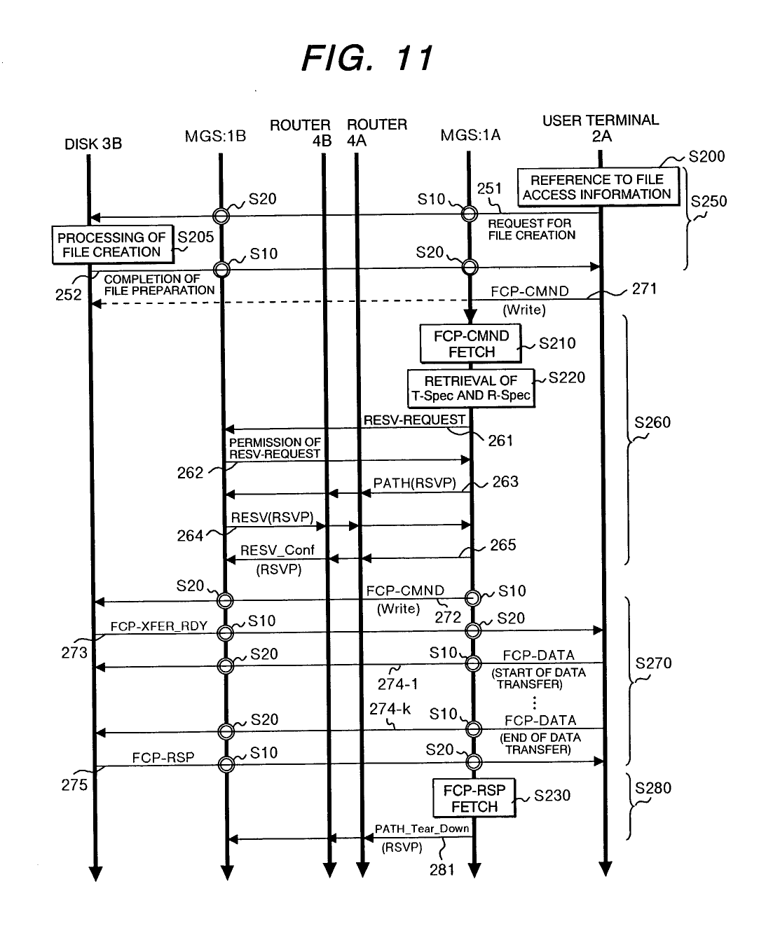

FIG. 11 shows a packet transfer sequence in the case where the user terminal 2A illustrated in FIG. 1 writes file data to the disk 3B.

The packet transfer sequence is comprised of a preprocess sequence (S250), a path setting/bandwidth reservation sequence (S260), a block data transfer sequence (S270), and a path release sequence (S280). In a manner similar to FIG. 10, the path setting/bandwidth reservation sequence (S260) is executed prior to the block data transfer sequence (S270). The block data transfer sequence (S270) of the embodiment corresponds to a write sequence in which the user terminal 2A operates as an SCSI initiator and the disk 3B operates as an SCSI target in the SCSI-FCP.

In the preprocess sequence (S250), the user terminal 2A refers to file information (S200), specifies the data size (transfer length) of a data file to be transferred to the disk 3B, and requests the disk 3B to create a file (251). The disk 3B creates a new data file area having the size requested by the user (S205), and notifies the user terminal 2A of completion of file preparation (252). The notification includes logical unit number (LUN) of new data file and a logical block address (LBA).

The user terminal 2A generates an FCP command FCP-CMND (write) by applying LUN and LBA obtained from the notification of file preparation complete and the data size of a file to be transferred and transmits the command to the disk 3B (271).

In this embodiment, in a manner similar to FIG. 10, the FCP-CMND (write) is fetched by the MGS 1A (S210) and the path setting/bandwidth reservation sequence (S260) is started. In the path setting/bandwidth reservation sequence (S260), the bandwidth control parameters (T-spec and R-spec) adapted to the data size indicated by the FCP-CMND (write) are retrieved (S220).

In the writing operation, the data transfer direction is opposite to that in the reading operation. In this embodiment, consequently, the transmission direction of the path bandwidth reservation message RESV(RSVP) is opposite to that of FIG. 10. The MGS 1A transmits an RESV request for execution of the path bandwidth reservation procedure to the MGS 1B on the disk 3B side (261). The RESV request includes entry information registered in the RSVP path management table 38A in accordance with the FCP-CMND(write).

When the RESV request is accepted, an RESV request permission message is returned from the MGS 1B to the MGS 1A (262). When the RESV request permission message is received, the MGS 1A transmits a message PATH(RSVP) for path setting to the MGS 1B (263), whereby a communication path is set between the two MGSs. After that, a message RESV(RSVP) for reserving a desired bandwidth on the communication path is transmitted from the MGS 1B to the MGS 1A (264), and a confirmation message RESV-conf(RSVP) is transmitted from the MGS 1A to the MGS 1B (265), whereby a desired bandwidth by the RSVP is reserved on the communication path between the MGSs 1A and 1B.

On completion of the path setting/bandwidth reservation sequence (S260), the MGS 1A transmits the FCP-CMND(write) temporarily held therein to the disk 3B (272), thereby starting a block data transfer sequence S270.

If it is ready to receive file data, the disk 3B transmits a transfer preparation complete message “FCP-XFER-RDY” to the user terminal 2A (273) in response to the FCP-CMND(write). When the message FCP-XFER-RDY is received, the user terminal 2A starts the transmission of file data as FCP-DATA on the unit basis of a data block having a predetermined data size (274-1, 274-2, . . . ).

When the user terminal 2A transmits FCP-DATA including the last block of the file data (274-k), an FCP response “FCP-RSP” is returned from the disk 3B (275), and the block data transfer sequence (S270) is completed. When the FCP-RSP is received, the MGS 1A starts the path release sequence (S280). Since the path release sequence (S280) is similar to the path release sequence (S180) described in FIG. 10, the description will not be repeated here.

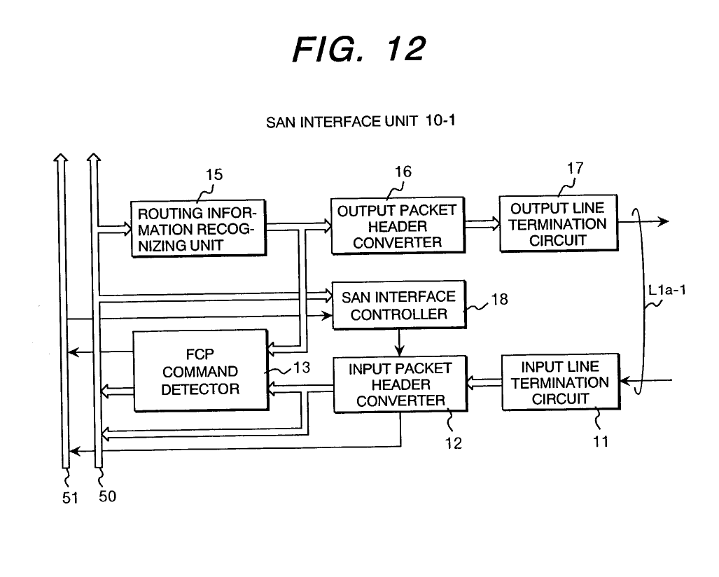

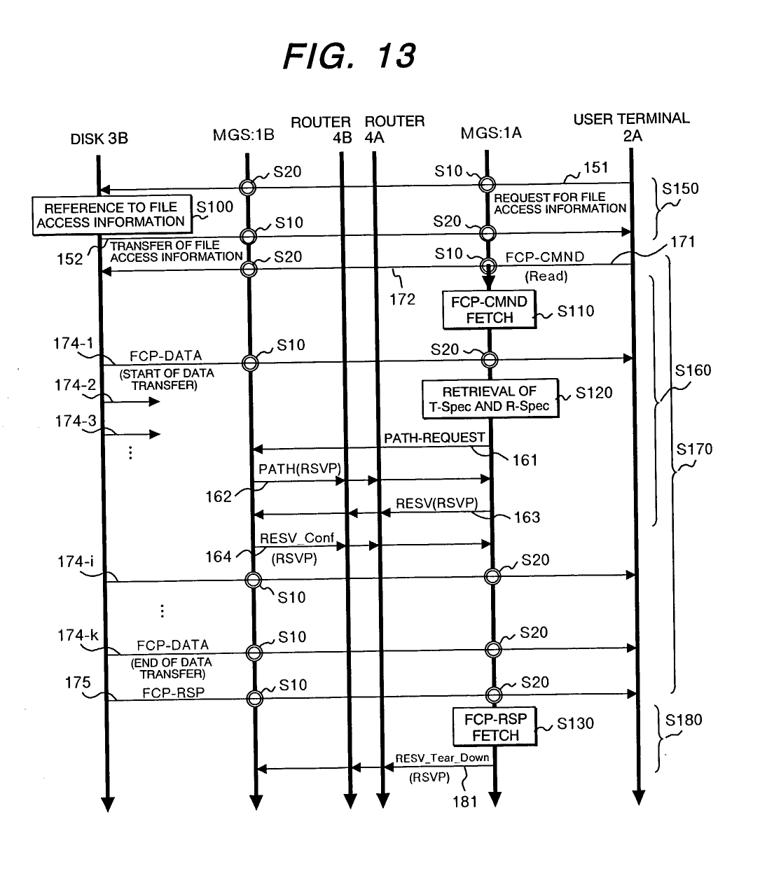

A second embodiment of an MGS according to the invention will now be described by referring to FIGS. 12 and 13.

FIG. 12 is a block diagram of the SAN interface unit 10-1 in each of the MGSs 1A and 1B of the second embodiment. The second embodiment is characterized in that the input packet header converter 12 outputs internal packets having routing information destined for the IP interface unit 20 parallelly to the TCP command detector 13 and the data bus 50.

In the case where the internal packet received from the input packet header converter 12 is the FCP-CMND, the TCP command detector 13 rewrites routing information of the internal header to routing information destined for the path controller 30, and outputs the resultant packet to the data bus 50. The TCP command detector 13 discards internal packets other than the FCP-CMND.

According to the second embodiment, therefore, while the path controller 30 executes the path setting/bandwidth reservation sequence of RSVP in response to the FCP-CMND, the FCP-CMND output from the input packet header converter 12 to the data bus 50 is transmitted from the IP interface unit 20 to the IP network 5, so that transfer of block data from the disk and the path setting/bandwidth reservation sequence of the RSVP are started in parallel. In this embodiment, when the path setting/bandwidth reservation sequence is completed, the path controller 30 does not have to execute the step 316 of transferring the FCP-CMND to the IP interface unit 20. According to the embodiment, the bandwidth is reserved in the block data transfer sequence and, during the data transfer, the communication path is switched to the RSVP communication path having the optimum bandwidth.

FIG. 13 shows a packet transfer sequence in the case where the user terminal 2A accesses the disk 3B via the MGSs 1A and 1B having the configuration of the second embodiment to read out file data.

As compared with the packet transfer sequence of the first embodiment described in FIG. 10, the second embodiment is characterized in that, after completion of the preprocess sequence (S150), the FCP-CMND (171) transmitted from the user terminal 2A is immediately transferred from the MGS 1A to the disk 3B (172), and the disk 3B starts a block data transfer sequence (S170) while the MGS 1A is executing the path setting/bandwidth reservation sequence (S160).

The path setting/bandwidth reservation sequence (S160) is carried out in a manner similar to the first embodiment. When the RSVP path bandwidth is reserved, the communication path is switched, and transmission data (FCP-DATA 174-i to 174-k) transmitted thereafter are transferred using the RSVP path bandwidth. The path release sequence (S180) is performed in a manner similar to the first embodiment.

According to the second embodiment, the FCP-CMND is executed without waiting for the end of the path setting/bandwidth reservation sequence (S160), so that the response to the user terminal 2A from the disk 3B is quickened. Since the communication path is switched to a dedicated path having the optimum bandwidth during the data transfer, the time required to transfer the file data can be shortened.

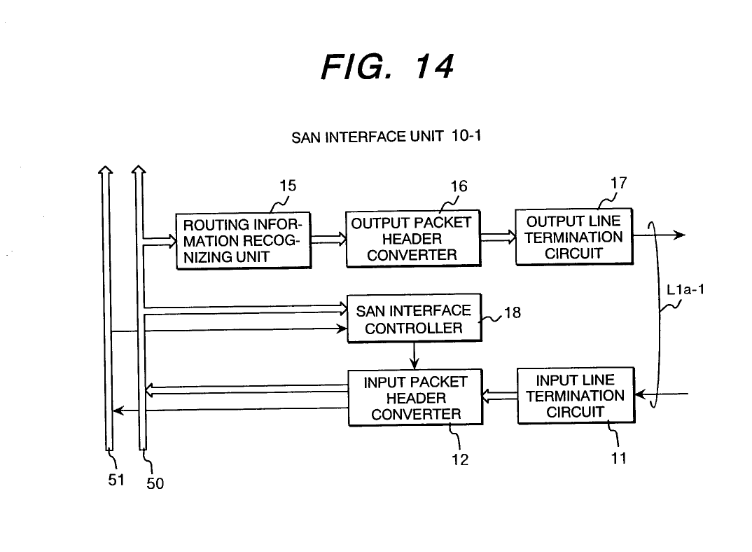

Referring now to FIGS. 14 to 21, a third embodiment of the MGS according to the invention will be described. The third embodiment is characterized in that setting and release of a path bandwidth is instructed from the user terminal.

FIG. 14 shows the configuration of the SAN interface unit 10-1 used for the MGSs 1A and 1B of the third embodiment.

The SAN interface unit 10-1 of the third embodiment does not have the TCP command detector 13, and all of internal packets subjected to header conversion by the input packet header converter 12 are transmitted to the data bus 50. Therefore, the FCP command is not fetched in the path controller 30.

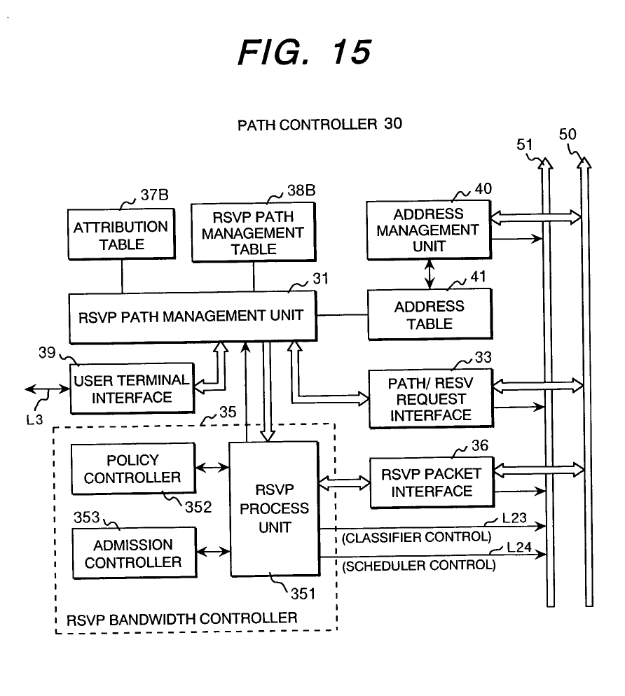

FIG. 15 shows the configuration of the path controller 30 used for the MGSs 1A and 1B of the third embodiment.

As compared with the first embodiment shown in FIG. 6, the path controller 30 of the third embodiment is characterized by including a user terminal interface 39 connected to a dedicated line L3 in place of the FCP packet interface 32. The dedicated line L3 is a signal line provided separately from the FC transmission line L1a to connect the user terminal 2A and the path controller 30 shown in FIG. 1.

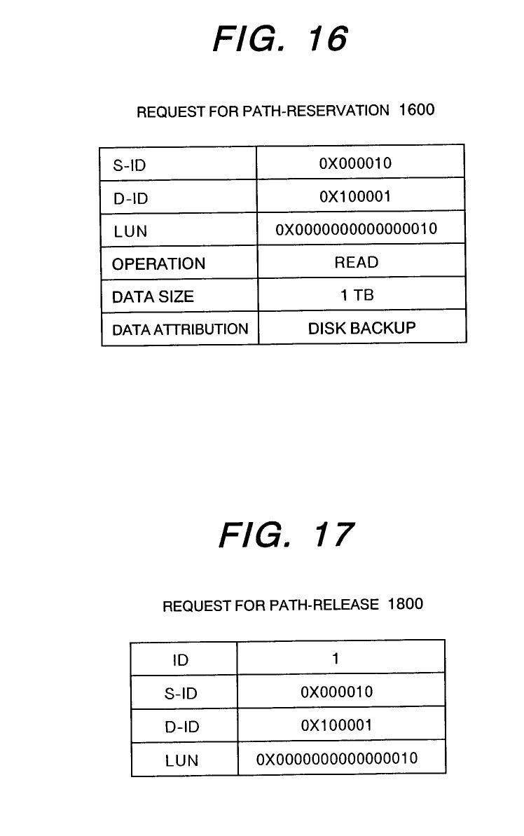

The user terminal interface 39 receives, for example as shown in FIG. 16, a request 1600 for path reservation including file access information such as address information S-ID and D-ID, LUN, operation code, data size (transfer data length), and data attribution from the user terminal 2A via the dedicated line L3, and supplies the request 1600 to the RVSP path management unit 31. The file access information is obtained by a file access information request to the disk.

When the request 1600 for path reservation is received, the RSVP path management unit 31 performs path setting and optimum bandwidth setting according to the file access information. Parameter values necessary for path setting are retrieved from an attribution table 37B by using the data attribution extracted from the file access information of the path reservation request as a search key.

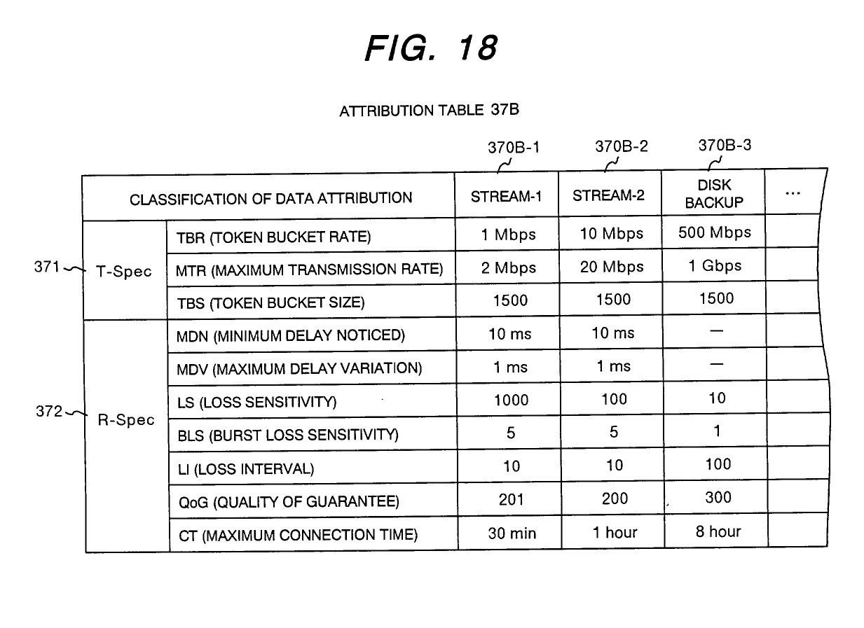

In the attribution table 37B, for example as shown in FIG. 18, a first parameter group T-spec 371 and a second parameter group R-spec 372 are designated for each of classifications 370B-1, 370B-2, . . . of data attribution. In the embodiment, the T-spec 371 includes the same parameters as those of the T-spec of the first embodiment shown in FIG. 8, and the R-spec 372 includes the parameters of the R-spec of the first embodiment shown in FIG. 8 and, in addition, maximum connection time (CT).

The RSVP path management unit 31 registers a new entry corresponding to the request for path reservation into the RSVP management table 38B by using the parameter values retrieved from the attribution table 37B.

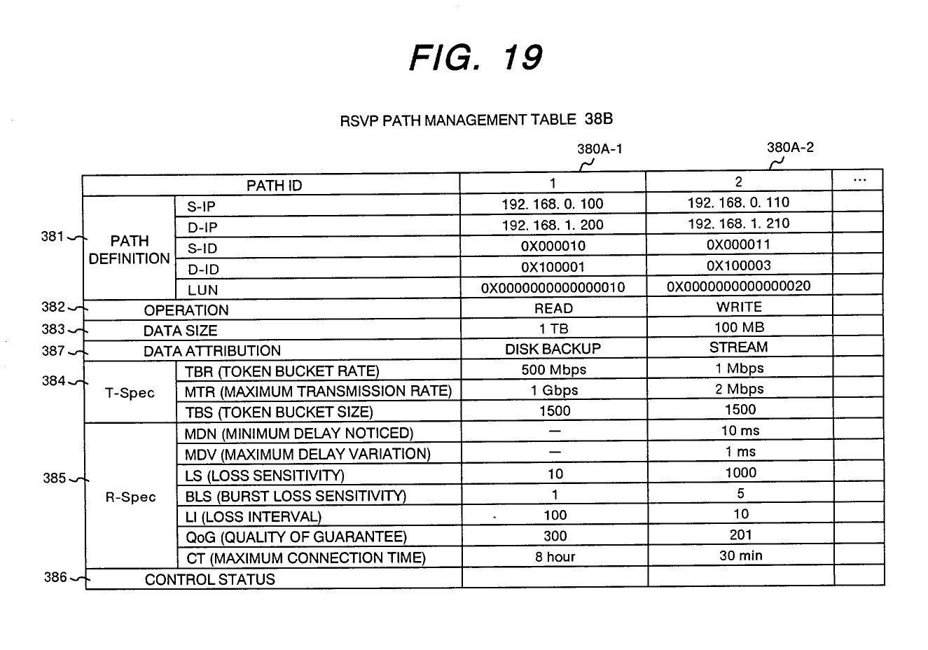

The RSVP management table 38B is comprised of, for example, as shown in FIG. 19, a plurality of entries 380B-1, 380B-2, . . . each having a path ID. Each entry includes the path definition information 381, operation 382, transfer data length (data size) 383, T-spec 384, R-spec 385, data attribution 387, and control status 386.

The RSVP management table 38B have the same items as those of the RSVP management table 38A of the first embodiment shown in FIG. 9 except for the data attribution 387 and R-spec 385. In the third embodiment, the maximum connection time (CT) is added to the R-spec 385. The values of the S-IP address and the D-IP address included in the path definition information 381 are obtained by searching the address table 41 on the basis of the S-ID and D-ID indicated by the path reservation request 1600.

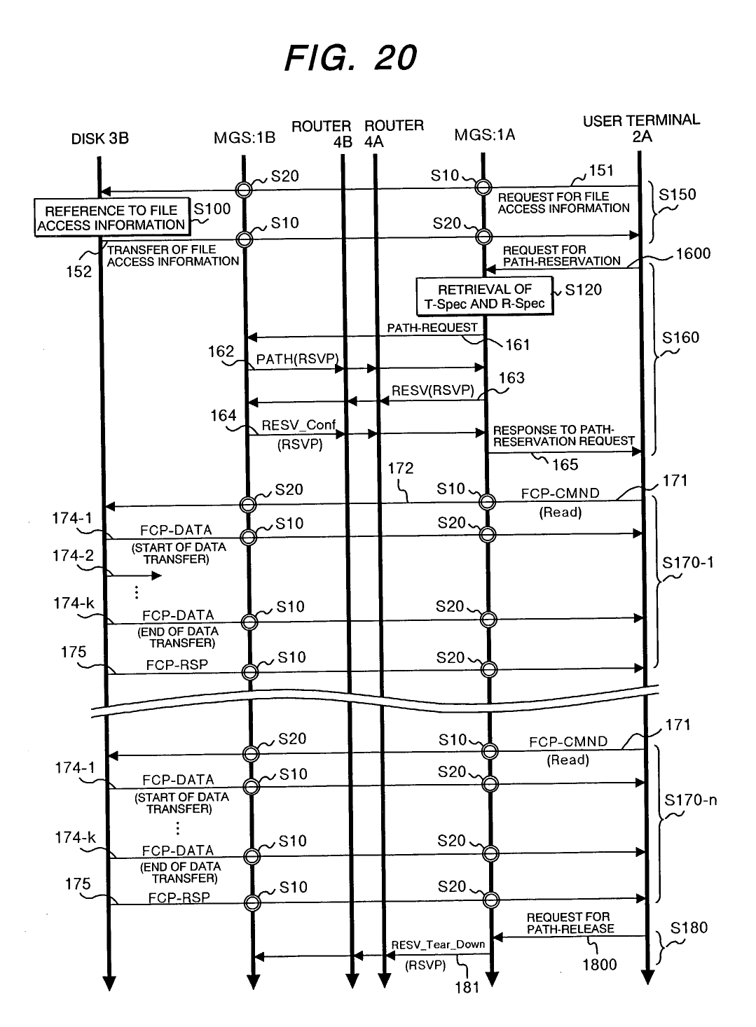

FIG. 20 shows a packet transfer sequence in the case where the user terminal 2A accesses the disk 3B to read out file data via the MGS of the third embodiment.

After executing the preprocess sequence S150 shown in FIG. 10, when the user terminal 2A transmits the request 1600 for path reservation to the MGS 1A via the dedicated line L3, the path setting/bandwidth reservation sequence S160 is started.

On receipt of the request 1600 for path reservation, the path controller 30 of the MGS 1A obtains the bandwidth control parameters (T-spec and R-spec) from the attribution table 27B (S120), and executes a procedure of path setting (161, 162) similar to that in the first embodiment described by referring to FIG. 10 and the bandwidth reservation (163, 164). When the path bandwidth is reserved, the path controller 30 (RVSP path management unit 31) of the MGS A1 notifies the user terminal 2A of completion of the path reservation via the user terminal interface 39 (165)

When the notification of path reservation complete is received, the user terminal 2A transmits (171) the FCP-CMND(read) to the transmission path L1a-1. The FCP-CMND(read) is transferred to the IP network 5 via the SAN interface 10-1, data bus 50, and IP interface unit 20 (172) and received by the disk 3B, and a data transfer sequence 170-1 is started. When a series of data transfer (FCP-DATA 174-1 to 174-k) in response to the FCP-CMND is completed, an FCP-RSP is transmitted from the disk 3B, and the data transfer sequence 170-1 is completed.

The user terminal 2A can repeatedly execute the data transfer sequences 170-1 to 170-n a plurality of times by transmitting the next FCP-CMND each time the data transfer sequence is completed. When the access to the disk is finished, a request 1800 for path release is issued from the user terminal 2A to the MGS 1A via the dedicated line L3. The request 1800 for path release indicates, for example as shown in FIG. 17, values of path-ID, S-ID, D-ID, and LUN registered in the RSVP path management table 38B.

Upon receiving the request 1800 for path release via the user interface 39, the RSVP path management unit 31 of the MGS 1A reads out an applicable entry from the RSVP path management table 38B, and instructs the RSVP bandwidth controller 35 to release the path. By the instruction, a path release command of the RSVP (RESV_Tear_Down) is issued to the MGS 1B and the RSVP path is released. The entry which becomes unnecessary due to the path release is eliminated from the RSVP path management table 38B.

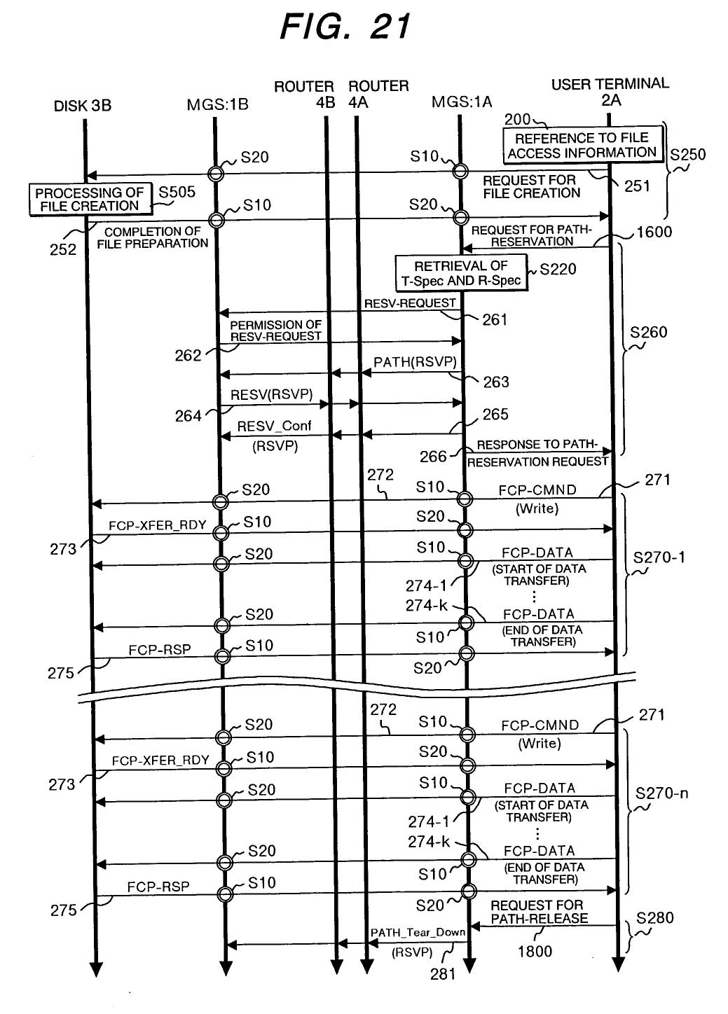

FIG. 21 shows a packet transfer sequence in the case where the user terminal 2A writes file data to the disk 3B via the MGS of the third embodiment.

The user obtains file attribute information including data size (transfer data length) and data attribution indicative of the purpose of the data utilization by referring to file information of the data file to be transferred to the disk 3B (200) and executes a preprocess sequence (S250) similar to that of FIG. 11. When the user terminal 2A requests the disk 3B to create a file (251), the disk 3B creates a requested file (S505), and transmits a notification of file preparation complete including a logical unit number (LUN) and logical block address (LBA) to the user terminal 2A (252).

When the preprocess sequence (S250) is completed and the request 1600 for path reservation is transmitted from the user terminal 2A to the MGS 1A via the dedicated line L3, the MGS 1A starts a path setting/bandwidth reservation sequence S260. Upon receiving the request 1600 for path reservation, the path controller 30 of the MGS 1A obtains the bandwidth control parameters (T-spec and R-spec) from the attribution table 27B (S220), executes a procedure of setting a path to the MGS 1B (261 to 263) and reserves the bandwidth (264 and 265) in a manner similar to the first embodiment described by referring to FIG. 11.

When the path bandwidth is reserved, the path controller 30 (RSVP path management unit 31) of the MGS 1A notifies the user terminal 2A of completion of path reservation (a response to the path reservation request) via the user terminal interface 39 (266).

Upon receiving the notification of the path reservation complete, the user terminal 2A transmits the FCP-CMND(write) to the transmission line L1a-1 (271). The FCP-CMND (write) is transferred to the IP network 5 via the SAN interface 10-1, data bus 50, and IP interface unit 20 (272), and a data transfer sequence 270-1 is started.

When a transfer preparation complete message FCP-XFER-RDY is transmitted from the disk 3B to the user terminal 2A in response to the FCP-CMND (write), the user terminal 2A starts the transmission of file data as FCP-data on the unit basis of a data block having a predetermined data size (274-1, 274-2, . . . ). When the user terminal 2A transmits the last FCP-DATA including the last data block (274-k), the FCP-RSP is transmitted from the disk 3B (275), and the data transfer sequence 170-1 is completed.

The user terminal 2A can repeatedly executes the data transfer sequences 170-1 to 170-n a plurality of times by transmitting the next FCP-CMND each time the data transfer sequence is completed. When the access to the disk is finished, the user terminal 2A transmits the request 1800 for path release to the MGS 1A via the dedicated line L3.

Upon receiving the request 1800 for path release via the user interface 39, the RSVP path management unit 31 of the MGS 1A reads out the applicable entry from the RSVP path management table 38B, and instructs the RSVP bandwidth controller 35 to release the path. By the instruction, a path release command of the RSVP (RESV_Tear_Down) is issued to the MGS 1B and the RSVP path is released. An entry which becomes unnecessary due to the path release is eliminated from the RSVP path management table 38B.

In the third embodiment, data attributes are designated by the request 1600 for path reservation given from the user terminal to the MGS 1A, and the MGS 1A reads out the bandwidth control parameter values corresponding to the data attribute from the attribution table 37B. It is also possible to designate the transfer data length by the request 1600 for path reservation and obtain the bandwidth control parameter values from the attribution table 37A similar to that of the first embodiment.

As obviously understood from the foregoing embodiments, by the switching node of the invention, the optimum path can be dynamically set on a relay network (IP network) in accordance with the size or attribution of file data to be transferred. When transfer of file data in response to a command is finished, by immediately releasing a path which becomes unnecessary, the network resources can be effectively used. According to the invention, therefore, in the case of accessing a remote storage apparatus, efficient communication assuring communication quality can be performed via a communication path having an optimum bandwidth adapted to the type, characteristic, or length of data to be transferred such as video data, design data, or text file data.

What is claimed is:

1. A switching node apparatus comprising:
a first interface for connection to a relay network;
a plurality of second interfaces for connection to an area network; and
a path controller having an attribution table defining various bandwidth control parameters for each of size classifications of data to be transferred,
wherein when a packet including a command for accessing a remote storage apparatus connected to said relay network is received from one of said second interfaces, said path controller reads out the bandwidth control parameters in the classification of the data size corresponding to a transfer data length indicated by said received command from said attribution table and executes a communication procedure for setting a path having a reserved bandwidth on said relay network in accordance with the bandwidth control parameters.

2. The switching node apparatus according to claim 1, wherein said first interface, said second interfaces, and said path controller are connected to each other via an internal data bus,
each of said second interfaces has means for adding routing information destined for said path controller to a command packet for accessing said remote storage apparatus and transmitting the resultant packet to said internal data bus, and
said path controller adds routing information destined for said first interface to said command packet and transmits the resultant packet to said internal data bus when the communication procedure for setting the path having the reserved bandwidth is completed.

3. The switching node apparatus according to claim 2, wherein a fibre channel protocol (FCP) is applied to said area network, the Internet Protocol (IP) is applied to said relay network, and
said second interface has a function of protocol conversion between FCP packets and IP packets.

4. The switching node apparatus according to claim 1, wherein said first interface, said second interfaces, and said path controller are connected to each other via an internal data bus,
each of said second interfaces has means for adding routing information destined for said first interface to a command packet for accessing said remote storage apparatus and transmitting the resultant packet to said internal data bus, and means for adding routing information destined for said path controller to said command packet and transmitting the resultant packet to said internal data bus, and
said communication procedure for setting the path having a reserved bandwidth is carried out in parallel with execution of the command by said remote storage apparatus.

5. The switching node apparatus according to claim 4, wherein a fibre channel protocol (FCP) is applied to said area network, the Internet Protocol (IP) is applied to said relay network, and said second interface has a function of a protocol conversion between FCP packets and IP packets.

6. The switching node apparatus according to claim 1, wherein said path controller has a path management table for storing therein bandwidth control parameters read out from said attribution table in correspondence with a command for accessing said remote storage apparatus and definition information of said path of which bandwidth is reserved.

7. A switching node apparatus comprising:
a first interface for connection to a relay network;
a plurality of second interfaces for connection to an area network;
a third interface for connection to a user terminal in said area network via a dedicated line; and
a path controller having an attribution table defining various bandwidth control parameters for each of attribution classifications of data to be transferred,
wherein when a path reservation request designating a data attribution is received from said third interface, said path controller reads out bandwidth control parameters in the attribution classification corresponding to said designated data attribution from said attribution table, and executes a communication procedure for setting a path having a reserved bandwidth on said relay network in accordance with the bandwidth control parameters, and
data is transferred between said user terminal and a remote storage apparatus via said path having the reserved bandwidth in accordance with a command received there after from one of said second interfaces.

8. The switching node apparatus according to claim 7, wherein a fibre channel protocol (FCP) is applied to said area network, the Internet Protocol (IP) is applied to said relay network, and
said second interface has a function of protocol conversion between FCP packets and IP packets.

9. A method of accessing a remote storage apparatus in a network including a first storage area network and a second storage area network connected to a relay network via a first switching node and a second switching node, respectively, comprising the steps of:
transmitting a file access instruction from a computer apparatus belonging to said first storage area network to a storage apparatus belonging to said second storage area network;
receiving the file access instruction by said first switching node;
executing a communication procedure for setting a communication path on said relay network by said first switching node in cooperation with said second switching node while holding transfer of said instruction to said relay network, said communication path having a reserved bandwidth adapted to a transfer data length designated by said instruction; and
after the communication path is set, transferring said file access instruction from the first switching node to said storage apparatus, whereby performing data transfer according to the file access instruction between said computer apparatus and said storage apparatus via the communication path.

10. The method of accessing a remote storage apparatus according to claim 9, wherein said computer apparatus performs communication with said storage apparatus prior to transmission of said file access instruction and obtains a transfer data length to be designated by said file access instruction.

11. The method of accessing a remote storage apparatus according to claim 9, further comprising the steps of:
transmitting a control command from said storage apparatus to said computer apparatus on completion of data transfer according to said file access instruction; and
transmitting a message for releasing the communication path having the reserved bandwidth, from said first switching node to said second switching node in response to said control command.

12. A method of accessing a remote storage apparatus in a network including a first storage area network and a second storage area network connected to a relay network via a first switching node and a second switching node, respectively, comprising the steps of:
transmitting a file access instruction from a computer apparatus belonging to said first storage area network to a storage apparatus belonging to said second storage area network;
transferring the instruction to said relay network by said first switching node;
executing a communication procedure for setting a communication path on said relay network by said first switching node in cooperation with said second switching node, said communication path having a reserved bandwidth adapted to a transfer data length designated by said instruction;
after said file access instruction is received by said storage apparatus, performing data transfer according to said file access instruction between said computer apparatus and the storage apparatus via a standard communication path; and
after said communication path having the reserved bandwidth is set, performing data transfer according to said file access instruction between said computer apparatus and the storage apparatus via the communication path having the reserved bandwidth.

13. The method of accessing a remote storage apparatus according to claim 12,
wherein said computer apparatus performs communication with said storage apparatus prior to transmission of said file access instruction and obtains a transfer data length to be designated by said file access instruction.

14. The method of accessing a remote storage apparatus according to claim 12, further comprising the steps of:
transmitting a control command from said storage apparatus to said computer apparatus on completion of data transfer according to said file access instruction; and
transmitting a message for releasing said communication path having the reserved bandwidth from said first switching node to said second switching node in response to said control command.

15. A method of accessing a remote storage apparatus in a network including a first storage area network and a second storage area network connected to a relay network via a first switching node and a second switching node, respectively, comprising the steps of:
sending a request for reserving a communication path for accessing a storage apparatus belonging to said second storage area network, from a computer apparatus belonging to said first storage area network to said first switching node;
receiving the request by said first switching node;
executing a communication procedure for setting a communication path on said relay network by said first switching node in cooperation with said second switching node and, on completion of the communication procedure, notifying said computer apparatus of reservation of the communication path, said communication path having a reserved bandwidth adapted to a data attribution designated by said request; and
after reception of said notification of reservation of said communication path, transmitting a file access instruction from said computer apparatus to said disk, whereby performing data transfer according to said file access instruction between said computer apparatus and the disk apparatus via said communication path having the reserved bandwidth.
